(19) United States
(12) Patent Application Publication
(10) Pub. No.: US 2018/0363159 A1
(43) Pub. Date: Dec. 20, 2018

(54) METHOD FOR PRODUCING A TIMEPIECE COMPONENT

(71) Applicant: ROLEX SA, Geneva (CH)

(72) Inventors: Ann-Kathrin Audren, Chêne-Bougeries (CH); Denis Favez, Le Grand-Saconnex (CH); Claire Manaranche-Boyes, Bienne (CH)

(73) Assignee: ROLEX SA, Geneva (CH)

(21) Appl. No.: 16/060,502

(22) PCT Filed: Dec. 12, 2016
(86) PCT No.: PCT/EP2016/080679

§ 371 Date: Jun. 8, 2018

(30) Foreign Application Priority Data
Dec. 18, 2015 (EP) 15201068.2

(51) Int. Cl. C25D 3/56; C09D 5/44; C25D 5/50; C25D 7/00

(52) U.S. Cl. CPC C25D 3/562; C25D 7/005; C25D 5/50; C09D 5/448

(57) ABSTRACT

The invention relates to a method for producing a timepiece component, characterised in that it comprises an electrodeposition step consisting in depositing an alloy on a substrate, forming at least one flank of the timepiece component with a thickness greater than or equal to 50 μm, said electrodeposition step being carried out with an electrolyte solution comprising a nickel-containing compound and a second nickel-free compound at concentrations such that the alloy obtained comprises between 91 and 99.8 wt.-% nickel and between 0.2 and 6 wt.-%, or even between 0.2 and 4 wt.-%, of a second element from the second compound.

The present invention relates to a process for manufacturing a component by electrodeposition. The invention also relates to the use of such a process for the manufacture of timepiece components, in particular of a timepiece movement. It also relates to a timepiece component as is, and also to a timepiece movement and a timepiece incorporating such a timepiece component.

It is known to use nickel to manufacture a timepiece component by electroforming. In particular, nickel is used for manufacturing springs, due to its good elastic properties. A deposition of pure nickel, a common solution in the field of electrodeposition, requires an electrolyte that is as clean as possible, free of solid particles, of metallic contaminations or of an excess of organic components. The electroforming of nickel conforms to multiple and complex parameters. A person skilled in the art must in particular control the composition of the electrolytic bath, its homogeneity over time and also the temperatures and current densities during the electrodeposition, in order to obtain the good mechanical properties of the final component as a function of the desired thickness. One problem lies in particular in the control of the stresses induced in the material deposited by the electrodeposition process. It is furthermore noted that the larger the thickness of material deposited, the greater the influence of these internal stresses, for example the crack resistance of the part thus produced.

Furthermore, the response of the component obtained by such a process to the mechanical stresses changes over time, in particular due to stress relaxation. For example, a significant loss of strength of a spring thus obtained is noted when it is constantly subjected to an elastic deformation. Similarly, such a component encounters creep problems over time. Naturally, these phenomena greatly reduce the reliability of such a component used in a timepiece movement.

To reduce these drawbacks, document US 2014/0269228 uses a nickel alloy comprising between 10% and 30% by weight of iron, and also a proportion of between 0.005% and 0.2% by weight of sulfur. With such an alloy, the iron intermingles in solid solution randomly in the crystal lattice of the nickel, causing a distortion of the crystal lattice that makes it possible to obtain a component with improved behavior. However, this solution has the drawback of introducing a ferromagnetic element into the alloy and of increasing the magnetic susceptibility of the parts thus produced, which is not recommended for a timepiece application.

Other nickel alloys are also used in the prior art for manufacturing components by electroforming, for example a nickel-phosphorus Ni—P alloy. Several commercial Ni—P baths exist, which comprise for example nickel sulfamate, nickel sulfate and nickel chloride, boric acid and phosphorus introduced in the form of phosphoric acid or phosphorous acid. These baths make it possible to obtain a component comprising a large amount by weight of phosphorus. However, the known Ni—P alloys and the associated electrodeposition process are not completely satisfactory for the reasons mentioned above.

Thus, the objective of the present invention is to provide an improved solution for manufacturing a component by electroforming.

More specifically, one subject of the invention is a solution for manufacturing a component by electroforming that makes it possible to improve the performance of the component obtained with respect to creep and relaxation phenomena observed in the prior art, particularly in order to obtain a component having elastic properties that are stable over time, even if a stress is applied thereon permanently or quasi-permanently. One objective of the invention is thus to obtain a reliable component suitable for a timepiece application.

For this purpose, the invention is based on a process for manufacturing a timepiece component, characterized in that it comprises an electrodeposition step consisting in depositing an alloy on a substrate, forming at least one side wall of the timepiece component having a thickness greater than or equal to 50 microns, this electrodeposition step being carried out using an electrolytic bath comprising a compound containing nickel and a nickel-free second compound, comprising in particular phosphorus or an element among boron B, bismuth Bi, carbon C, chlorine Cl, calcium Ca, indium In, manganese Mn, tin Sn or zirconium Zr, in proportions such that the alloy obtained comprises a weight content of nickel of between 91% and 99.8% inclusive and between 0.2% and 6% inclusive, or even between 0.2% and 4% inclusive, by weight of a second element originating from the second compound. As a variant, the alloy obtained comprises a weight content of nickel of between 94% and 99.8% inclusive or between 96% and 99.8% inclusive.

The invention is more particularly defined by the claims.

These subjects, features and advantages of the present invention will be disclosed in detail in the following description of particular embodiments given non-limitingly in connection with the appended figures among which:

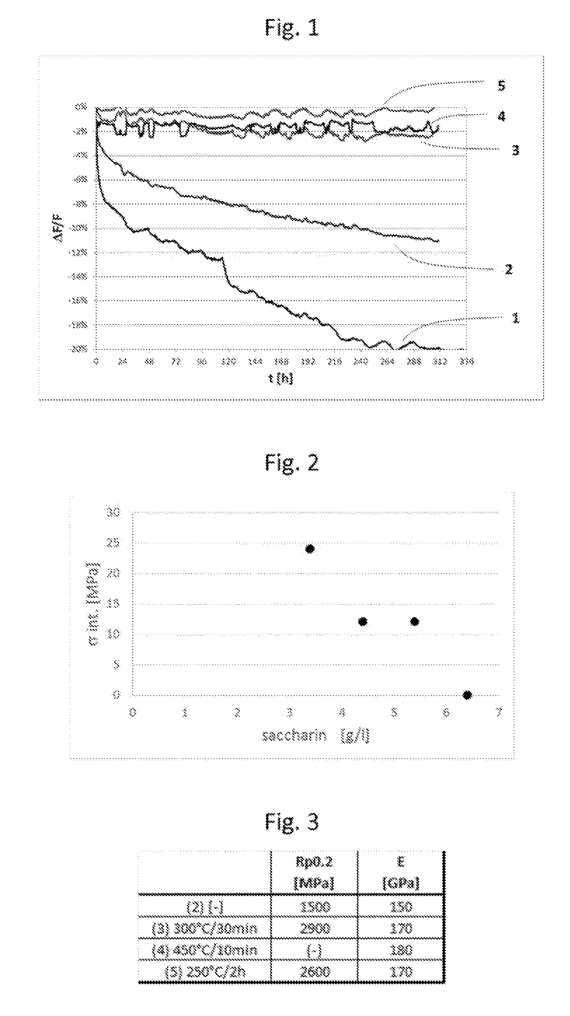

FIG. 1 illustrates curves of the change over a period of five hours in the loss of strength of electroformed nickel or nickel-phosphorus Ni—P components that have undergone various heat treatments.

FIG. 2 illustrates the effect of saccharin in an electrodeposition step of a process for manufacturing a timepiece component according to one embodiment of the invention.

FIG. 3 represents the results of flexural tests obtained for various heat treatments of an electroformed nickel-phosphorus Ni—P component according to the embodiment of the invention.

The embodiment of the invention relates firstly to a thick component, that is to say having a thickness greater than or equal to 50 microns, or a portion of which has a thickness greater than or equal to 50 microns. For such a thickness, it is impossible to ignore the consequences of the possible internal stresses within the component, which induce cracks, either during the manufacture of the component, or when the use thereof subjects it to a mechanical stress, such as in the case of a timepiece movement spring. Note that this technical problem is on the contrary negligible for thinner thicknesses for which the internal stresses have little effect.

Moreover, the preferred embodiment of the invention is based on the use of an alloy based on nickel and phosphorus Ni—P, with a small proportion of phosphorus, as will be explained in detail subsequently. Note that all the proportions mentioned in this document for the elements used in an alloy are percentages by weight.

The embodiment of the invention therefore comprises the implementation of a process for manufacturing a component based on Ni—P by electroforming. Electroforming as such is carried out with devices known from the prior art, on a substrate optionally covered with a layer that forms the electrode, for example by a LIGA, photolithography and galvanic deposition technique. The alloy thus deposited is then detached from the substrate in order to form the final component. According to the embodiment of the invention, the process for manufacturing a component therefore comprises at least one electrodeposition step consisting in forming a thick layer of alloy, all in one block. Note that it is not excluded to then carry out other electrodeposition steps in order to form at least one other layer, and for example to form a multilayer component, or steps of fastening by any means another subpart of the component to the thick electrodeposited layer mentioned above.

For this, the process according to the embodiment uses an electrolytic bath that departs from the customary composition of a pure nickel or nickel-phosphorus bath from the prior art. This bath according to the embodiment of the invention thus in particular comprises a brightener, and more particularly saccharin, which may for example be added to conventional components such as those present in an Ni—P bath. The total content of these various elements of the electrolytic bath according to the embodiment of the invention is such that the amount of phosphorus finally obtained in the electrodeposited component is less than or equal to 6%, so as to avoid the amorphous domain. This proportion may, as a variant, be less than or equal to 4%. It is in any case preferably greater than or equal to 0.2%. The embodiment of the invention thus combines a small amount of phosphorus in an electroformed component made of Ni—P alloy with a large thickness, which goes against the preconceptions of a person skilled in the art for whom it was accepted that such a component would inevitably encounter problems of cracking and would not be usable. Indeed, a low content of phosphorus leads to a magnetic, crystalline alloy which is subjected to such internal tensile stresses when it is deposited conventionally that the thicknesses are generally small. Thicker deposits thus obtained exhibit a high risk of cracking.

As an exemplary embodiment of the invention, an electrolytic bath used may have the following composition: 90 g/l of Ni and 6 g/l of Cl, 5 g/l of B, 0.2 g/l of phosphorus, and 15 ml/l of a commercial brightener Niron84. This bath makes it possible to obtain, by means of a deposition at 50° C. over 2 hours and under a current density of 2.7 A/dm², a component comprising 3.9% by weight of phosphorus and having a thickness of 60 microns.

Another exemplary embodiment of the invention uses an electrolytic bath composed of 90 g/l of Ni and 20 g/l of Cl, 5 g/l of B, 0.2 g/l of phosphorus, 16 ml/l of a commercial brightener Niron84 and 2 g/l of saccharin. This bath makes it possible to obtain, by means of a deposition at 50° C. over 4 hours and under a current density of 2.7 A/dm², a component comprising 0.22% by weight of phosphorus and having a thickness of 100 microns.

According to another exemplary embodiment of the invention, an electrolytic bath used may have the following composition: 105 g/l of Ni and 20 g/l of Cl, 5 g/l of B, 6 g/l of phosphorus and 1.5 g/l of saccharin. This bath makes it possible to obtain, by means of a deposition at 60° C. over 18 hours and under a current density of 1.5 A/dm², a component comprising 2.4% by weight of phosphorus and having a thickness of 300 microns.

Another exemplary embodiment of the invention uses an electrolytic bath composed of 90 g/l of Ni and 20 g/l of Cl, 5 g/l of B, 3.2 g/l of phosphorus and 5 g/l of saccharin. This bath makes it possible to obtain, by means of a deposition at 50° C. over 4 hours and under a current density of 2.7 A/dm², a component comprising 1.2% by weight of phosphorus and having a thickness of 100 microns.

According to another exemplary embodiment of the invention, an electrolytic bath used may have the following composition: 90 g/l of Ni and 20 g/l of Cl, 5 g/l of B, 8 g/l of phosphorus and 6 g/l of saccharin. This bath makes it possible to obtain, by means of a deposition at 50° C. over 12 hours and under a current density of 2.7 A/dm², a component comprising 1.8% by weight of phosphorus and having a thickness of 350 microns.

Such electrodepositions furthermore make it possible to obtain very sizeable deposited thicknesses, for example up to 700 microns.

The preceding examples finally make it possible to obtain a binary Ni—P alloy. As a variant, the following exemplary embodiments make it possible to obtain a ternary nickel-based alloy.

One exemplary embodiment uses an electrolytic bath composed of 90 g/l of Ni and 20 g/l of Cl, 5 g/l of B, 8 g/l of phosphorus, 1 g/l of cobalt and 6.5 g/l of saccharin. This bath makes it possible to obtain, by means of a deposition at 60° C. over 48 hours and under a current density of 1.5 A/dm², a crystalline component comprising 1.8% by weight of phosphorus and 5.8% by weight of cobalt, and having a thickness of around 70 microns.

Another exemplary embodiment uses an electrolytic bath composed of 90 g/l of Ni and 20 g/l of Cl, 5 g/l of B, 8 g/l of phosphorus, 1 g/l of cobalt and 8 g/l of saccharin. This bath makes it possible to obtain, by means of a deposition at 60° C. over 4 hours and under a current density of 1.5 A/dm², a crystalline component comprising 1.6% by weight of phosphorus and 6.3% by weight of cobalt, and having a thickness of around 54 microns.

Another exemplary embodiment uses an electrolytic bath composed of 90 g/l of Ni and 20 g/l of Cl, 5 g/l of B, 8 g/l of phosphorus, 1 g/l of cobalt and 10 g/l of saccharin. This bath makes it possible to obtain, by means of a deposition at 60° C. over 4 hours and under a current density of 1.5 A/dm², a crystalline component comprising 1.4% by weight of phosphorus and 5.5% by weight of cobalt, and having a thickness of around 51 microns.

Note that an embodiment using an electrolytic bath composed of 90 g/l of Ni and 6 g/l of Cl, 5 g/l of B, 2.25 g/l of phosphorus and 10 ml/l of a commercial brightener Niron84 was attempted. This bath makes it possible to obtain, by means of a deposition at 60° C. over 2 hours and under a current density of 2.7 A/dm², an amorphous component comprising 8% by weight of phosphorus and having a thickness of around 49 microns. It turned out that this phosphorus content gives a result with an amorphous material, which does not withstand creep. Thus, to avoid this drawback, one advantageous solution consists in limiting the weight content of phosphorus to a value of less than or equal to 6%.

According to the embodiment of the invention, the electrolytic bath therefore comprises at least one brightener, preferably at least 1 g/l of brightener, in order to limit the internal stresses and prevent the cracking of the component. Advantageously, the brightener is saccharin. Advantageously, an amount of saccharin between 3 and 8 g/l is present in the electrolytic bath. The addition of saccharin makes it possible to pass from a state of internal tensile stresses to a state of internal compressive stresses, which is markedly more favorable toward maintaining the properties of the electroformed material. Note that the saccharin is not used with a nickel-phosphorus alloy in the prior art since it inhibits the deposition of phosphorus and limits it to a small proportion, whereas the approaches of the prior art consist in seeking a large proportion of phosphorus. Furthermore, the saccharin content of the bath must be monitored accurately since, as organic additive, it degrades and renders the electrodeposition bath unstable, which is an additional argument for not using it in the prior art. On the contrary, in the embodiment of the invention, saccharin is even used as the sole brightener, that is to say that any other base brightener is completely removed from the bath in favor of the saccharin.

FIG. 2 illustrates the effect of the saccharin. It specifically represents the internal stresses obtained in various electroformed components using an electrolytic bath as described in detail above for several saccharin proportions, by means of a deposition at 50° C. with a pH of between 1.5 and 3.1 and under a current density of 2.7 A/dm².

Operationally, the internal stresses are measured by means of a strip strain gauge, more specifically using copper tongues comprising two parts, one of which is coated by electrodeposition. The measurement of the gap between the two parts of the tongue, with and without coating, makes it possible to deduce the internal stress of the coating therefrom.

Theoretically, the stress S (in psi) is calculated from:

S=UKM/3T

where
U represents the gap measured on the equipment,
K represents the constant linked to the type of strip used,
M represents the modulus of elasticity of the deposition relative to that of the substrate, and
T represents the thickness deposited.

A positive stress indicates that the surface is under tension, a negative stress indicates a compression of the surface. In the case of being under tension, the risk of cracking is high.

In all the cases, when the composition of the electrolytic bath has been optimized as described above, the electrodeposition must also advantageously be carried out under favorable conditions. For this, it appears that these favorable conditions are achieved for a temperature between 40° C. and 60° C., preferably between 45° C. and 55° C., and ideally substantially equal to 50° C. They are also achieved for a pH of the solution between 1.5 and 4.1, preferably between 1.5 and 3.5, ideally substantially equal to 3.0. Finally, the applied current density is preferably between 1.0 and 3.5 A/dm², or even between 2.0 and 3.5 A/dm², ideally substantially equal to 2.7 A/dm².

Note that during the implementation of these electrodeposition processes, in general there is inevitably a deposition of impurities. Thus, the component obtained may comprise small amounts of iron and copper. It also contains traces of boron, carbon and sulfur. The proportions used to define the final product obtained sometimes disregard these impurities.

According to an advantageous variant of the embodiment of the invention, the process for manufacturing an electroformed component comprises an additional heat treatment step, which follows the electrodeposition step.

Advantageously, this heat treatment is carried out at a relatively low temperature compared to the heat treatments customarily perceived as useful in the field of manufacturing components by electroforming. In particular, such a heat treatment is preferably carried out at a temperature below or equal to 370° C. This temperature may be between 150° C. and 350° C. inclusive, or even between 200° C. and 320° C. inclusive, or even between 220° C. and 270° C.

The table from FIG. 3 illustrates in particular the increase in the elastic limit with the heat treatment. It makes it possible to compare the results without heat treatment and with heat treatments having temperatures of 450° C., 300° C. and 250° C. It emerges that a temperature of 450° C. is for example too high because it induces brittle behavior of the component by precipitation of the Ni₃P phase. The two tests at 250° C. and 300° C. are satisfactory.

FIG. 1 likewise illustrates the effect of the heat treatment on the relaxation of an electroformed component according to the embodiment with and without heat treatment, over a period of 13 days. Curve 1 illustrates the result obtained with a pure nickel component without heat treatment, according to the prior art. A loss of strength of around 20% is observed after 13 days. Curve 2 illustrates the result obtained with a nickel-phosphorus component according to the invention, without heat treatment. It corresponds to the first line of the table from FIG. 3. The curves 3, 4, 5 illustrate the results obtained, respectively, for heat treatments at 300° C. for 30 minutes, 450° C. for 10 minutes, and 250° C. for two hours. In the three cases, the loss of strength is less than or equal to 3% after 13 days. It is noted that the best result is achieved for the lowest temperature, of 250° C. Note that these three curves 3, 4, 5 correspond respectively to the last three lines of the table from FIG. 3. More generally, the heat treatment may be carried out at a temperature above or equal to 300° C. for a period of less than or equal to 30 minutes. As a variant, it may be carried out at a temperature between 240° C. and 260° C., or even between 200° C. and 270° C., for a period greater than or equal to 1 hour and less than or equal to 2 hours. Naturally, a compromise will be chosen between the temperature and the duration of the heat treatment. The higher the temperature, the shorter the duration.

The embodiment of the invention was described using an Ni—P alloy. As embodiment variants, the phosphorus, used in the preferred embodiment, may be replaced by one of the following elements: boron B, bismuth Bi, carbon C, chlorine Cl, calcium Ca, indium In, manganese Mn, tin Sn or zirconium Zr. As a variant, it may be replaced by one of the following elements: bismuth Bi, carbon C, chlorine Cl, calcium Ca, indium In, manganese Mn, tin Sn or zirconium Zr.

According to another embodiment variant, the alloy may be formed of two elements added to the nickel Ni, in order to form a three-element alloy. The first element added may be phosphorus or one of the elements listed above, and the second element added may be among: iron (Fe), chromium (Cr), cobalt (Co), copper (Cu), manganese (Mn), palladium (Pd), platinum (Pt), zinc (Zn).

Finally, according to other embodiment variants, other alloys may be obtained by replacing the nickel from the alloys described previously with another metal, particularly copper or aluminum. In all cases, the nickel, or the alternative element such as copper and aluminum, will be in a large amount in the electrolytic bath and the component obtained, preferably in a proportion greater than or equal to 91%, or even greater than or equal to 94%, greater than or equal to 96%.

The invention also relates to the component as such obtained by the manufacturing process described previously. This component, or at least the part of this component made of an alloy as described previously, has at least one side wall all in one block having a thickness greater than or equal to 50 microns produced in a step of electrodepositing a layer. The component may thus comprise zones of smaller thickness. The component may also comprise a total or partial superimposition of layers obtained according to the manufacturing process described previously. The component may furthermore include at least one second component such as a stone or finger made of ruby. The component may also comprise at least one portion, in particular a functional portion, made from a material other than an Ni—P alloy.

It furthermore comprises a first metallic element such as nickel, or even copper or aluminum, in a large amount, in a proportion of greater than or equal to 91%, and less than or equal to 99.8%, and at least one second element such as phosphorus, or one of the alternative elements listed above, in a small amount, between 0.2% and 6% inclusive, or even between 0.2% and 4% inclusive. The alloy may comprise two elements, or even three according to the variants described above. The alloy may naturally furthermore comprise impurities, that can be disregarded relative to the other elements mentioned. Thus, the alloy mentioned may consist of the two or three elements mentioned, and therefore be binary or ternary (the possible impurities are then disregarded). Note that the component obtained, and in particular its alloy described previously, therefore has a large thickness and cannot be compared to a simple surface coating. According to one embodiment, the alloy mentioned occupies the entire thickness of the component. As a variant, it does not occupy the entire thickness of the component, or on a portion of the component only. According to another advantageous example, the alloy mentioned does not comprise boron and/or does not comprise thallium.

Such a component is advantageously used in a timepiece movement, and in a timepiece. Particularly, the timepiece use of thick electroformed components made of nickel-phosphorus alloy with a low content of phosphorus is particularly advantageous, since these components prove particularly resistant to creep. This advantage originates in particular from the fact that these components comprise little or no internal stress despite their considerable thickness. Such a component may also be used for any other subpart of a timepiece, such as a watch case or clasp for example.

In particular, the process for manufacturing a component as described previously may advantageously be used for manufacturing timepiece components such as, by way of illustrative and nonlimiting example, a spring, a spring lever, a jumper, a pallet, a wheel, a rack, a balance, a cam, a gear or else a bridge. Such a component may comprise at least two separate levels.

Finally, the invention also relates to a timepiece, such as a watch, in particular a wristwatch, which comprises a component as described previously.

1. A process for manufacturing a timepiece component, comprising:
performing an electrodeposition by depositing an alloy on a substrate, forming at least one side wall of the timepiece component having a thickness greater than or equal to 50 microns,
wherein the electrodeposition is carried out using an electrolytic bath comprising a compound containing nickel and a nickel-free second compound, containing an element selected from the group consisting of phosphorus P, boron B, bismuth Bi, carbon C, chlorine Cl, calcium Ca, indium In, manganese Mn, tin Sn and zirconium Zr, in proportions so that the alloy obtained has a weight content of between 91% and 99.8% inclusive of nickel and a weight content between 0.2% and 6% inclusive of a second element originating from the second compound.

2. The process for manufacturing a timepiece component as claimed in claim 1, wherein the electrolytic bath comprises a nickel-free third compound comprising an element selected from the group consisting of iron Fe, chromium Cr, cobalt Co, copper Cu, manganese Mn, palladium Pd, platinum Pt, and zinc Zn.

3. The process for manufacturing a timepiece component as claimed in claim 1, wherein the electrolytic bath is configured so as to make it possible to form an alloy consisting of nickel, a second element originating from the second compound, and optionally a third element originating from a nickel-free third compound.

4. The process for manufacturing a component as claimed in claim 1, wherein the second compound of the electrolytic bath contains phosphorus P.

5. The process for manufacturing a timepiece component as claimed in claim 1, wherein the electrolytic bath comprises at least one brightener in an amount greater than or equal to 1 g/l.

6. The process for manufacturing a timepiece component as claimed in claim 5, wherein the electrolytic bath comprises saccharin.

7. The process for manufacturing a timepiece component as claimed in claim 6, wherein the saccharin is the only brightener of the electrolytic bath.

8. The process for manufacturing a timepiece component as claimed in claim 1, wherein the electrodeposition comprises at least one selected from the group consisting of:
applying an electrolytic bath temperature of from 40° C. to 60° C.,
choosing a pH of the solution of from 1.5 to 4.1,
applying a current density of from 1.0 to 3.5 A/cm².

9. The process for manufacturing a timepiece component as claimed in claim 1, comprising performing a heat treatment of the component obtained after the electrodeposition, at a temperature between 150° C. and 350° C. inclusive, so as to improve the performance of the component obtained with respect to creep and/or relaxation phenomena.

10. The process for manufacturing a timepiece component as claimed in claim 9, wherein the heat treatment is carried out at a temperature above or equal to 300° C. for a duration of less than or equal to 30 minutes.

11. The process for manufacturing a timepiece component as claimed in claim 1, which is configured to make it possible to manufacture a timepiece component selected from the group consisting of a spring, a spring lever, a jumper, a pallet, a wheel, a rack, a balance, a cam, a gear, and a bridge.

12. An electroformed timepiece component obtained by a manufacturing process as claimed in claim 1, comprising an alloy of at least first and second elements different from one another, the first element being nickel, in a proportion by weight of between 91% and 99.8% inclusive, and the second element being selected from the group consisting of phosphorus P, boron B, bismuth Bi, carbon C, chlorine Cl, calcium Ca, indium In, manganese Mn, tin Sn, and zirconium Zr, in a proportion by weight of between 0.2% and 6% inclusive, wherein the alloy comprises at least one side wall having a thickness of greater than or equal to 50 microns.

13. The electroformed timepiece component as claimed in claim 12, comprising a third element, different from the first and second elements, the third element being selected from the group consisting of iron Fe, chromium Cr, cobalt Co, copper Cu, manganese Mn, palladium Pd, platinum Pt, and zinc Zn.

14. The electroformed timepiece component as claimed in claim 12, comprising an alloy consisting of nickel, phosphorus P, and optionally a third element.

15. The electroformed timepiece component as claimed in claim 12, wherein the alloy comprises no boron and/or no thallium.

16. The electroformed timepiece component as claimed in claim 12, wherein the component is selected from the group consisting of a spring, a spring lever, a jumper, a pallet, a wheel, a rack, a balance, a cam, a gear, and a bridge.

17. A timepiece movement or timepiece subpart, comprising a timepiece component as claimed in claim 12.

18. A timepiece comprising a timepiece component as claimed in claim 12.

19. The process according to claim 1, wherein the alloy obtained has a weight content of between 0.2% and 4% inclusive of the second element originating from the second compound.

20. The process for manufacturing a timepiece component as claimed in claim 6, wherein the electrolytic bath comprises between 3 and 8 g/l inclusive of the saccharin.
